(19) United States
(12) Patent Application Publication
(10) Pub. No.: US 2026/0280870 A1
(43) Pub. Date: Sep. 17, 2026

(54) MEMBERSHIP ACCOUNT MANAGEMENT USING A CONTACTLESS CARD

(71) Applicant: Capital One Services, LLC, McLean, VA (US)

(72) Inventors: Kevin Osborn, Newton Highlands, MA (US); Srinivasa Chigurupati, Long Grove, IL (US)

(73) Assignee: Capital One Services, LLC, McLean, VA (US)

(21) Appl. No.: 19/555,432

(22) Filed: Mar. 3, 2026

Related U.S. Application Data
(63) Continuation of application No. 18/115,199, filed on Feb. 28, 2023, now Pat. No. 12,592,819.

(51) Int. Cl. H04L 9/08; G06K 7/10

(52) U.S. Cl. CPC H04L 9/088; G06K 7/10366

(57) ABSTRACT

Systems, methods, apparatuses, and computer-readable media for management of membership functions for members of a partner entity associated with contactless card cryptograms are described. For example, a method may include receiving a membership cryptogram generated by a contactless card in communication with the client device during a transaction, the contactless card associated with at least one partner entity having a plurality of members, decrypting the membership cryptogram based on at least one master key for the contactless card to determine a decryption result, authenticating the membership cryptogram based on the decryption result; and responsive to authentication of the membership cryptogram: determining a membership identifier for the transaction, determining a member of the plurality of members based on the membership identifier, and transmitting membership benefit information to the client device to facilitate at least one membership function associated with the member for the transaction. Other embodiments are described.

### RELATED APPLICATIONS

This application is a continuation of U.S. patent application Ser. No. 18/115,199, filed on Feb. 28, 2023, titled “MEMBERSHIP ACCOUNT MANAGEMENT USING A CONTACTLESS CARD”. The contents of the aforementioned application are incorporated herein by reference in their entirety.

### BACKGROUND

Enterprises, such as retailers, may employ membership accounts for customers to access features such as loyalty points, discounts, member-only purchases, and/or the like. A retailer, for example, a grocery store or shopping club, may provide a customer member with a membership identifier and a membership card. Typically, the membership identifier is printed on the back of the card, for instance, as a bar code. As such, there is a potential for fraud and misuse of this information, such as a card not present transaction.

Managing multiple membership cards involves the time-consuming process of cardholders calling a telephone number or visiting a website and entering or otherwise providing personal information. Further, while the growing use of chip-based financial cards provides more secure features over previous technologies (for example, magnetic strip cards) for in-person purchases, account access still typically relies on log-in credentials (for instance, username and password) to confirm a cardholder's identity and/or otherwise complete a transaction. However, if the log-in credentials are compromised, another person could have access to the user's account.

The problem of account security becomes exacerbated when attempting to efficiently accessing multiple accounts, as a single authorization credential or mechanism can pose an aggravated security risk if it is compromised, whether the account access relates to membership functions, payments, redemption activity, or general access. In addition, performing a transaction at a retailer using a membership account (for example, to access loyalty points, discounts, make authorized member purchases, and/or the like) and a payment card (for example, a credit card or debit card) typically requires the use of multiple cards or a combination of cards and login credential, which is inefficient and inconvenient for consumers.

Accordingly, there is a need to improve authentication mechanisms for membership account access and transactions processing, including payment and redemption transactions.

### SUMMARY

Systems, methods, apparatuses, and computer-readable media for managing membership functions of a partner entity using contactless card authentication are described. For example, in some embodiments, a method may include receiving a membership cryptogram generated by a contactless card in communication with the client device during a transaction, the contactless card associated with at least one partner entity having a plurality of members, decrypting the membership cryptogram based on at least one master key for the contactless card to determine a decryption result, authenticating the membership cryptogram based on the decryption result; and responsive to authentication of the membership cryptogram: determining a membership identifier for the transaction, determining a member of the plurality of members based on the membership identifier, and transmitting membership benefit information to the client device to facilitate at least one membership function associated with the member for the transaction.

In one embodiment, a system may include at least one server comprising a processor and a memory storing instructions that, when executed by the processor, cause the processor to: receive, via a client device, a membership cryptogram generated by a contactless card in communication with the client device during a transaction, the contactless card associated with at least one partner entity having a plurality of members, decrypt the membership cryptogram based on at least one master key for the contactless card to determine a decryption result, authenticate the membership cryptogram based on the decryption result, and responsive to authentication of the membership cryptogram: determine a membership identifier for the transaction, determine a member of the plurality of members based on the membership identifier, and transmit membership benefit information to the client device to facilitate at least one membership function associated with the member for the transaction.

In some embodiments of the system, the membership cryptogram may include a member identifier configured to identify a membership of a contactless card user with the at least one partner entity.

In various embodiments of the system, the membership cryptogram may include a partner identifier configured to identify the at least one partner entity.

In some embodiments of the system, the instructions, when executed by the processor, may cause the processor to determine a partner identifier stored on the contactless card, and route the membership cryptogram to a partner entity back-end system identified by the partner identifier.

In exemplary embodiments of the system, the partner identifier may be determined based on the decryption result.

In various embodiments of the system, the at least one master key may include a set of membership master keys.

In some embodiments of the system, the at least one partner entity may include at least one of a retailer, a shopping club, or a member-based entity.

In various embodiments of the system, the at least one membership function may include at least one of a discount, a reward, loyalty points, a coupon, a purchase privilege, or historical transaction information.

In one embodiment, a method may include. via at least one server of at least one back-end processing system, receiving, via a client device, a membership cryptogram generated by a contactless card in communication with the client device during a transaction, the contactless card associated with at least one partner entity having a plurality of members; decrypting the membership cryptogram based on at least one master key for the contactless card to determine a decryption result; authenticating the membership cryptogram based on the decryption result; and responsive to authentication of the membership cryptogram: determining a membership identifier for the transaction, determining a member of the plurality of members based on the membership identifier, and transmitting membership benefit information to the client device to facilitate at least one membership function associated with the member for the transaction.

In some embodiments of the method, the membership cryptogram may include a member identifier configured to identify a membership of a contactless card user with the at least one partner entity.

In various embodiments of the method, the membership cryptogram may include a partner identifier configured to identify the at least one partner entity.

In exemplary embodiments of the method, the method may further include determining a partner identifier stored on the contactless card, and routing the membership cryptogram to a partner entity back-end system identified by the partner identifier.

In some embodiments of the method, the partner identifier may be determined based on the decryption result.

In various embodiments of the method, the at least one master key may include a set of membership master keys.

In some embodiments of the method, the at least one partner entity may include at least one of a retailer, a shopping club, or a member-based entity.

In some embodiments of the method, the at least one membership function may include at least one of a discount, a reward, loyalty points, a coupon, a purchase privilege, or historical transaction information.

In some embodiments of the method, the at least one server may include a card-issuer server and a partner entity server.

In one embodiment, a non-transitory computer-readable storage medium may include instructions that, when executed by a processor, cause the processor to: receive, via a client device, a membership cryptogram generated by a contactless card in communication with the client device during a transaction, the contactless card associated with at least one partner entity having a plurality of members; decrypt the membership cryptogram based on at least one master key for the contactless card to determine a decryption result; authenticate the membership cryptogram based on the decryption result; and responsive to authentication of the membership cryptogram: determine a membership identifier for the transaction, determine a member of the plurality of members based on the membership identifier, and transmit membership benefit information to the client device to facilitate at least one membership function associated with the member for the transaction.

In some embodiments of the non-transitory computer-readable storage medium, the instructions, when executed by the processor, may cause the processor to determine a partner identifier stored on the contactless card, and route the membership cryptogram to a partner entity back-end system identified by the partner identifier.

In various embodiments of the non-transitory computer-readable storage medium, the at least one partner entity may include at least one of a retailer, a shopping club, or a member-based entity.

### BRIEF DESCRIPTION OF THE DRAWINGS

FIG. 1 illustrates an aspect of the subject matter in accordance with one embodiment.

FIG. 2 illustrates an aspect of the subject matter in accordance with one embodiment.

FIG. 3 illustrates a contactless card 102 in accordance with one embodiment.

FIG. 4 illustrates a transaction card component 400 in accordance with one embodiment.

FIG. 5 illustrates a sequence flow 500 in accordance with one embodiment.

FIG. 6 illustrates a data structure 600 in accordance with one embodiment.

FIG. 7 is a diagram of a key system according to an example embodiment.

FIG. 8 is a flowchart of a method of generating a cryptogram according to an example embodiment.

FIG. 9 illustrates an aspect of the subject matter in accordance with one embodiment.

FIG. 10 illustrates an aspect of the subject matter in accordance with one embodiment.

FIG. 11 depicts an exemplary operating environment consistent with some embodiments.

FIG. 12 depicts an exemplary computing architecture in accordance with some embodiments of the present disclosure.

FIG. 13 depicts an exemplary operating environment in accordance with some embodiments.

FIG. 14 illustrates an embodiment of a logic flow for processing a transaction using a contactless card according to some embodiments.

FIG. 15 illustrates an embodiment of an exemplary computer architecture suitable for implementing various embodiments.

### DETAILED DESCRIPTION

For the purposes of promoting an understanding of the principles of the present disclosure, reference will now be made to the embodiments illustrated in the figures and specific language will be used to describe the same. It will nevertheless be understood that no limitation of the scope of the disclosure is thereby intended. Any alterations and further modifications in the described embodiments, and any further applications of the principles of the present disclosure as described herein are contemplated as would normally occur to one skilled in the art to which the disclosure relates.

The described technology generally relates to managing membership of a partner entity using a contactless card. A partner entity may be or may include a retailer, shopping club, member-based entity (e.g., a gym, a health club, a country club, a sports club, etc.) that has members (or customers with a registered account). A contactless card may be generated with membership information, such as membership identifiers, partner entity identifiers, and/or the like stored directly on the card. In various embodiments, the contactless card may be configured to provide secure membership benefits, membership-based transactions, and/or the like (instead of or in addition to payment transactions). For example, the membership information (such as a member identifier) may be encrypted in a cryptogram. The cryptogram may be authenticated, for instance, via a card-issuer system or a partner entity system. Accordingly, membership functions and benefits may be securely and efficiently managed via a contactless card according to some embodiments.

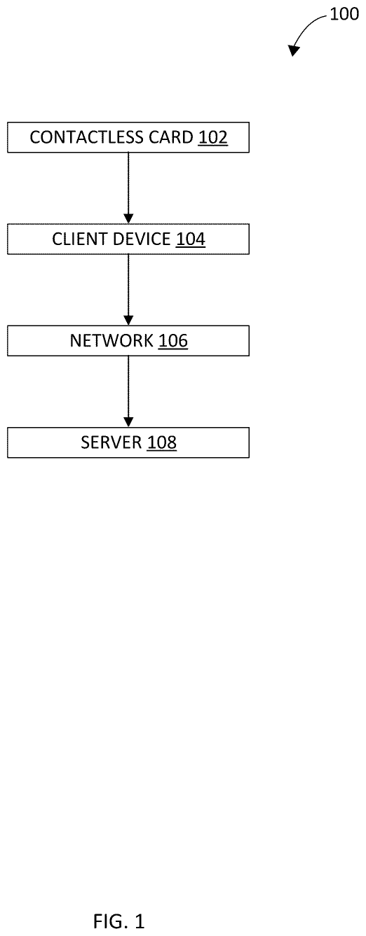

FIG. 1 illustrates a data transmission system 100 according to some embodiments. As further discussed below, system 100 may include contactless card 102, client device 104, network 106, and server 108. Although FIG. 1 illustrates single instances of the components, system 100 may include any number of components.

System 100 may include one or more contactless cards 102, which are further explained below. In some embodiments, contactless card 102 may be in wireless communication, utilizing near-field communication (NFC) in an example, with client device 104.

System 100 may include client device 104, which may be a network-enabled computer. As referred to herein, a network-enabled computer may include, but is not limited to, a computer device, or communications device including, e.g., a server, a network appliance, a personal computer, a workstation, a phone, a handheld PC, a personal digital assistant, a thin client, a fat client, an Internet browser, a point-of-sale device, combinations thereof, and/or the like. Client device 104 may also be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 104 can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 104 of system 100 may execute one or more applications, such as software applications, that enable, for example, network communications with one or more components of system 100 and transmit and/or receive data.

System 100 may include one or more servers 108. In some examples, server 108 may include one or more processors, which are coupled to memory. The server 108 may be configured as a central system, server, or platform to control and call various data at different times to execute a plurality of workflow functions according to some embodiments. Server 108 may be configured to connect to one or more databases (not shown). The server 108 may be connected to at least one client device 104.

System 100 may include one or more networks 106. In some examples, network 106 may be one or more of a wireless network, a wired network or any combination of wireless network and wired network, and may be configured to connect client device 104 to server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. Network 106 may further include one network, or any number of the exemplary types of networks mentioned above, operating as a stand-alone network or in cooperation with each other. Network 106 may utilize one or more protocols of one or more network elements to which they are communicatively coupled. Network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

The client device 104 may be in communication with one or more server(s) 108 via one or more network(s) 106 and may operate as a respective front-end (client device 104) to back-end (server 108) pair with server 108. The client device 104 may transmit, for example from a mobile device application executing on the client device 104, one or more requests to server 108. The one or more requests may be associated with retrieving data from the server 108. The server 108 may receive the one or more requests from client device 104. Based on the one or more requests from the client device 104, the server 108 may be configured to retrieve the requested data from one or more databases (not shown). Based on receipt of the requested data from the one or more databases, the server 108 may be configured to transmit the received data to the client device 104, the received data being responsive to one or more requests.

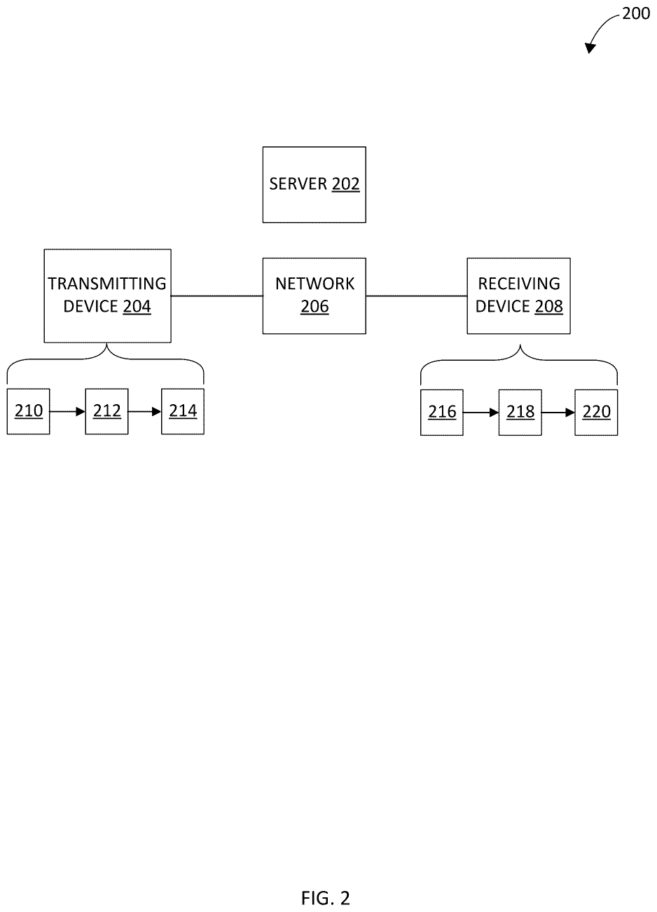

FIG. 2 illustrates a data transmission system according to an example embodiment. As shown in FIG. 2, a system 200 may include a transmitting or transmitting device 204, a receiving or receiving device 208 in communication, for example via a network 206, with one or more servers 202. The transmitting device 204 may be the same or similar to the client device 104 discussed above with reference to FIG. 1. The receiving device 208 may be the same or similar to the client device 104 discussed above with reference to FIG. 1. The network 206 may be the same or similar to the network 106 discussed above with reference to FIG. 1. The server 202 may be the same or similar to server 108 discussed above with reference to FIG. 1. Although FIG. 2 shows single instances of components of the system 200, the system 200 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data that the attacker has that was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data that the attacker is able to gather is limited, which thereby reduces exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used without needing to resort to any form of key exchange to keep the parties in sync. By periodically changing the shared secret symmetric key used by the sender and the recipient, the attacks described above are rendered impossible.

Referring back to FIG. 2, the system 200 may be configured to implement key diversification. For example, a sender and recipient may desire to exchange data (e.g., original sensitive data) via respective devices 204 and 208. As explained above, although single instances of the transmitting device 204 and the receiving device 208 may be included, it is understood that one or more transmitting devices 204 and one or more receiving devices 208 may be involved so long as each party shares the same shared secret symmetric key. In some examples, the transmitting device 204 and the receiving device 208 may be provisioned with the same master symmetric key. Further, it is understood that any party or device holding the same secret symmetric key may perform the functions of the transmitting device 204 and similarly any party holding the same secret symmetric key may perform the functions of the receiving device 208. In some examples, the symmetric key may comprise the shared secret symmetric key which is kept secret from all parties other than the transmitting device 204 and the receiving device 208 involved in exchanging the secure data. It is further understood that both the transmitting device 204 and the receiving device 208 may be provided with the same master symmetric key, and further that part of the data exchanged between the transmitting device 204 and the receiving device 208 comprises at least a portion of data which may be referred to as the counter value. The counter value may comprise a number that changes each time data is exchanged between the transmitting device 204 and the receiving device 208.

The system 200 may include one or more networks 206. In some examples, the network 206 may be one or more of a wireless network, a wired network or any combination of wireless network and wired network, and may be configured to connect one or more transmitting devices 204 and one or more receiving devices 208 to server 202. For example, the network 206 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, the network 206 may include, without limitation, telephone lines, fiber optics, IEEE Ethernet 902.3, a wide area network, a wireless personal area network, a LAN, or a global network such as the Internet. In addition, the network 206 may support an Internet network, a wireless communication network, a cellular network, or the like, or any combination thereof. Network 206 may further include one network, or any number of the exemplary types of networks mentioned above, operating as a stand-alone network or in cooperation with each other. The network 206 may utilize one or more protocols of one or more network elements to which they are communicatively coupled. The network 206 may translate to or from other protocols to one or more protocols of network devices. Although the network 206 is depicted as a single network, it should be appreciated that according to one or more examples, the network 206 may comprise a plurality of interconnected networks, such as, for example, the Internet, a service provider's network, a cable television network, corporate networks, such as credit card association networks, and home networks.

In some examples, one or more transmitting devices 204 and one or more receiving devices 208 may be configured to communicate and transmit and receive data between each other without passing through the network 206. For example, communication between the one or more transmitting devices 204 and the one or more receiving devices 208 may occur via at least one of NFC, Bluetooth, RFID, Wi-Fi, and/or the like.

At block 210, when the transmitting device 204 is preparing to process the sensitive data with symmetric cryptographic operation, the sender may update a counter. In addition, the transmitting device 204 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 212, the transmitting device 204 may take the selected cryptographic algorithm, and using the master symmetric key, process the counter value. For example, the sender may select a symmetric encryption algorithm, and use a counter which updates with every conversation between the transmitting device 204 and the receiving device 208. The transmitting device 204 may then encrypt the counter value with the selected symmetric encryption algorithm using the master symmetric key, creating a diversified symmetric key.

In some examples, the counter value may not be encrypted. In these examples, the counter value may be transmitted between the transmitting device 204 and the receiving device 208 at block 212 without encryption.

At block 214, the diversified symmetric key may be used to process the sensitive data before transmitting the result to the receiving device 208. For example, the transmitting device 204 may encrypt the sensitive data using a symmetric encryption algorithm using the diversified symmetric key, with the output comprising the protected encrypted data. The transmitting device 204 may then transmit the protected encrypted data, along with the counter value, to the receiving device 208 for processing.

At block 216, the receiving device 208 may first take the counter value and then perform the same symmetric encryption using the counter value as input to the encryption, and the master symmetric key as the key for the encryption. The output of the encryption may be the same diversified symmetric key value that was created by the sender.

At block 218, the receiving device 208 may then take the protected encrypted data and using a symmetric decryption algorithm along with the diversified symmetric key, decrypt the protected encrypted data.

At block 220, as a result of the decrypting the protected encrypted data, the original sensitive data may be revealed.

The next time sensitive data needs to be sent from the sender to the recipient via respective transmitting device 204 and receiving device 208, a different counter value may be selected producing a different diversified symmetric key. By processing the counter value with the master symmetric key and same symmetric cryptographic algorithm, both the transmitting device 204 and the receiving device 208 may independently produce the same diversified symmetric key. This diversified symmetric key, not the master symmetric key, is used to protect the sensitive data.

As explained above, both the transmitting device 204 and the receiving device 208 each initially possess the shared master symmetric key. The shared master symmetric key is not used to encrypt the original sensitive data. Because the diversified symmetric key is independently created by both the transmitting device 204 and receiving device 208, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 204 and the receiving device 208 may be governed by symmetric requirements for how often to create a new diversification value, and therefore a new diversified symmetric key. In an embodiment, a new diversification value and therefore a new diversified symmetric key may be created for every exchange between the transmitting device 204 and the receiving device 208.

In some examples, the key diversification value may comprise the counter value. Other non-limiting examples of the key diversification value include: a random nonce generated each time a new diversified key is needed, the random nonce sent from the transmitting device 204 to the receiving device 208; the full value of a counter value sent from the transmitting device 204 and the receiving device 208; a portion of a counter value sent from the transmitting device 204 and the receiving device 208; a counter independently maintained by the transmitting device 204 and the receiving device 208 but not sent between the two devices; a one-time-passcode exchanged between the transmitting device 204 and the receiving device 208; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 204 and the receiving device 208. In effect, this may create a one-time use key, such as a single-use session key.

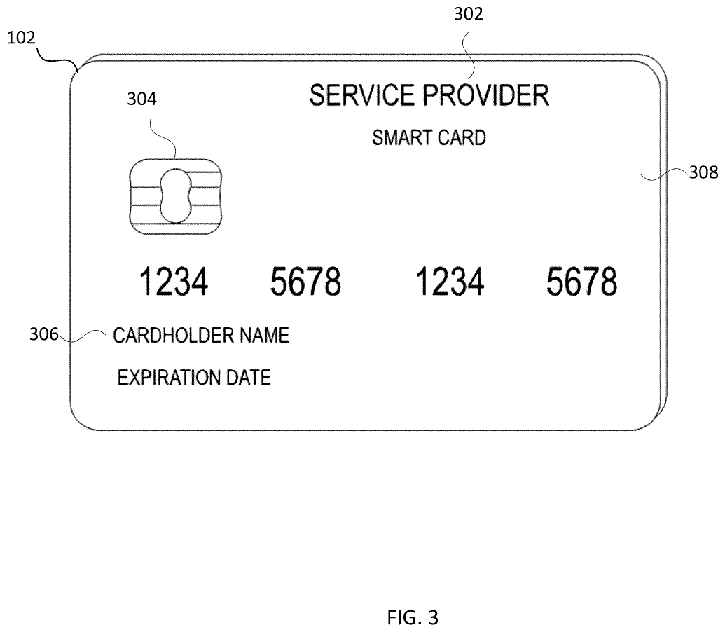

FIG. 3 illustrates an example configuration of a contactless card 102, which may include a contactless card, a payment card (such as a credit card or a debit card), a membership card, or gift card, issued by a service provider (for instance, which may be displayed as service provider indicia 302 on the front or back of the contactless card 102). In some embodiments, the contactless card 102 may be issued by a service provider in association with a partner entity (e.g., a retailer, shopping club, member-based enterprise, and/or the like). In such embodiments, the indicia may be or may include the name or other representation of the partner entity.

In some examples, the contactless card 102 is not related to a payment card, and may include, without limitation, an identification card, a membership card, a loyalty card, a rewards card, a purchase privilege card (e.g., members must have the card (or other proof of membership) in order to make purchases, for instance, at a shopping club), and/or the like. In some examples, the transaction card may include a dual interface contactless payment card, a membership card, a rewards card, and so forth. The contactless card 102 may include a substrate 308, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and/or the transaction card may otherwise be compliant with the ISO/IEC 14443 standard. However, it is understood that the contactless card 102 according to the present disclosure may have different characteristics, and the present disclosure does not require a transaction card to be implemented in a payment card.

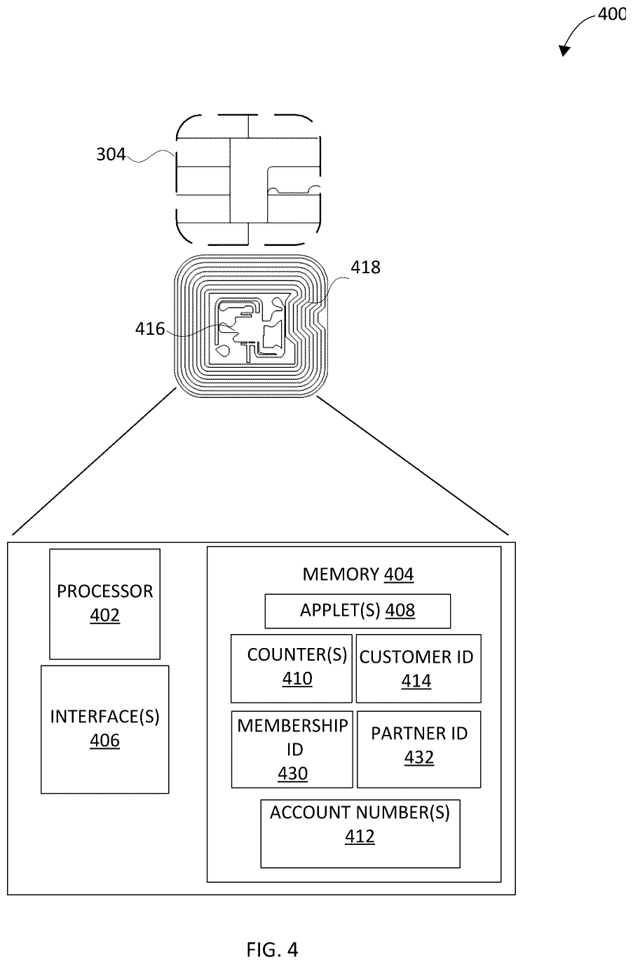

The contactless card 102 may also include identification information 306 displayed on the front and/or back of the card, and a contact pad 304. The contact pad 304 may include one or more pads and may be configured to establish contact with another client device, such as an ATM, a user device, smartphone, laptop, desktop, or tablet computer via transaction cards. The contact pad may be designed in accordance with one or more standards, such as ISO/IEC 7816 standard, and/or enable communication in accordance with the EMV protocol. The contactless card 102 may also include processing circuitry, antenna and other components as will be further discussed in FIG. 4. These components may be located behind the contact pad 304 or elsewhere on the substrate 308, e.g., within a different layer of the substrate 308, and may be electrically and physically coupled with the contact pad 304. The contactless card 102 may also include a magnetic strip or tape, which may be located on the back of the card (not shown in FIG. 3). The contactless card 102 may also include a Near-Field Communication (NFC) device coupled with an antenna capable of communicating via the NFC protocol. Embodiments are not limited in this manner.

As illustrated in FIG. 4, the contact pad 304 of contactless card 102 may include processing circuitry 416 for storing, processing, and communicating information, including a processor 402, a memory 404, and one or more interface(s) 406. It is understood that the processing circuitry 416 may contain additional components, including processors, memories, error and parity/CRC checkers, data encoders, anticollision algorithms, controllers, command decoders, security primitives and tamperproofing hardware, as necessary to perform the functions described herein.

The memory 404 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 404 may be encrypted memory utilizing an encryption algorithm executed by the processor 402 to encrypted data.

The memory 404 may be configured to store one or more applet(s) 408, one or more counter(s) 410, a customer identifier 414, a membership identifier 430, a partner identifier 432, account number(s) 412, which may be virtual account numbers, and/or the like. The one or more applet(s) 408 may include one or more software applications configured to execute on one or more contactless cards, such as a Java® Card applet. However, it is understood that applet(s) 408 are not limited to Java Card applets, and instead may be any software application operable on contactless cards or other devices having limited memory. The one or more counter(s) 410 may comprise a numeric counter sufficient to store an integer.

The customer identifier 414 may comprise a unique alphanumeric identifier assigned to a user of the contactless card 102, and the identifier may distinguish the user of the contactless card from other contactless card users. In some examples, the customer identifier 414 may identify both a customer and an account assigned to that customer and may further identify the contactless card 102 associated with the customer's account. As stated, the account number(s) 412 may include thousands of one-time use virtual account numbers associated with the contactless card 102. An applet(s) 408 of the contactless card 102 may be configured to manage the account number(s) 412 (e.g., to select an account number(s) 412, mark the selected account number(s) 412 as used, and transmit the account number(s) 412 to a mobile device for auto filling by an auto filling service).

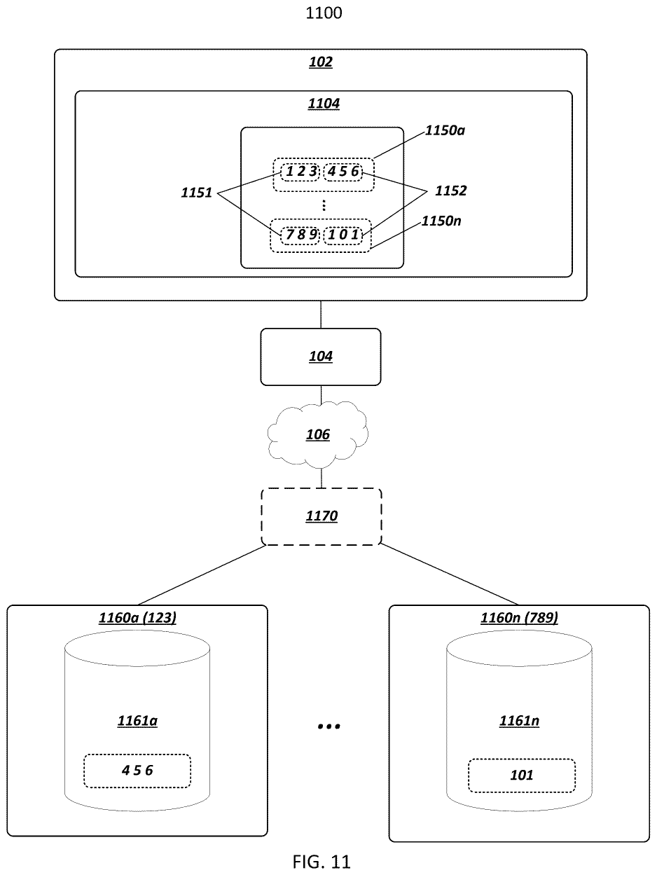

A membership identifier (membership ID or member ID) 430 may be a unique identifier assigned to a user of the card in relation to a partner entity enterprise (for instance, in some embodiments, an enterprise that may be separate from the card-issuer of contactless card 102) (see, for example, FIG. 11). For instance, a membership ID 430 may be a membership account identifier for a customer of a partner entity that includes, without limitation, a retailer, such as a grocery store, clothing retailer, e-commerce retailer, a shopping club, and/or the like. The membership ID 430 may be associated with a new or existing account that the user has with the enterprise (for instance, in some embodiments, that is separate from an account that the user has with the issuer of the contactless card). For example, a user may have a membership account with a shopping club that allows for certain member functions, benefits, and/or the like. For instance, the membership account may be required to purchase items at a shopping club, use/accumulate loyalty points, use/accumulate discounts, and/or the like. In some embodiments, the membership ID 430 may be for a partner enterprise, for example, a partner (e.g., retailer) associated with the card issuer (e.g., a bank or other financial institution). In other embodiments, the membership ID 430 may be for the card issuer (for instance, a retailer, shopping club, bank, financial institution, membership-based organization (e.g., a gym), combinations thereof, and/or the like).

In one example, a user may open a membership with a retailer and receive a membership account with a membership account number. The retailer (or an enterprise associated with the retailer) may be in partnership with the issuer of contactless card 102 to manage membership functions during transactions using the contactless card 102. The user may then obtain a contactless card 102 and have their membership account number (with the retailer) be assigned as a membership ID 430 of the contactless card 102.

In some embodiments, the membership ID 430 with the enterprise may be separate from the customer identifier (e.g., customer ID 414) associated with an issuer/manager of the contactless card 102. In exemplary embodiments, the customer ID 414 may be the membership ID 430 (i.e., there is only one unique alphanumeric identifier assigned to the user of the contactless card 102, which is the membership ID 430). Accordingly, in some embodiments, reference to a customer ID, account number, card ID, or other unique ID for the contactless card 102 may refer to the membership ID 430.

In various embodiments, a contactless card 102 may be associated with one membership ID 430. In some embodiments, a contactless card 102 may be associated with a plurality of member IDs 430 (for example, for one or more enterprises having membership functions managed by the contactless card 102). In this manner, a single contactless card 102 may be used in connection with multiple member IDs 430 for multiple enterprises (for instance, a grocery store membership, a gym membership, and/or the like). In various embodiments, the membership ID 430 may be used in combination with and/or in place of the account numbers 412 and/or customer ID 414 in various embodiments, for instance, where the account numbers 412 are used for various functions, such as encryption/decryption, key generation, and/or the like. In exemplary embodiments, the membership ID 430 may be used in place of the customer ID 414 (for instance, the customer ID 414 may be the membership ID 430). In some embodiments, the membership ID 430 may be used for membership functions associated with the membership and the account numbers 412 and/or customer ID 414 may be used to process payment functions (e.g., credit card functions, debit card functions, and/or the like). Accordingly, a single contactless card 102 may be used to manage both membership functions and transaction/payment functions.

A partner identifier (partnership identifier, partnership ID, or partner ID) 432 may be an identifier of the enterprise associated with the membership ID 430. For example, the enterprise may be a retailer, shopping club, gym, and/or other organization having members. The partner enterprise may be in partnership with the card-issuer of the contactless card 102 to manage the membership during transactions with the contactless card 102. In some embodiments, the partner ID 432 may be used to identify a particular partner entity and to route information to a processing or back-end system associated with the partner entity. A contactless card 102 may be able to work with multiple different partner entities, including on the same card. For example, a contactless card 102 may be set up for members of Partner Entity A, Partner Entity B, . . . , Partner Entity N. Each of Partner Entities A-N may be assigned a unique partner ID so that the contactless card 102 (and any processing systems associated with the contactless card 102 and processing/transmitting data thereof) may know how to handle the data and/or where to transmit the data for processing, member lookup, and/or the like.

For example, Partner Entity A may have a partner ID 432 of “123” and Partner Entity B may have a partner ID 432 of “456.” Data, transactions, and/or the like with a partner ID 432 “123” may be handled according to the process for Partner Entity A (for instance, the membership ID is sent to the Partner Entity A back-end system) and data, transactions, and/or the like with a partner ID 432 of “456” may be handled according to the process for Partner Entity B.

Typically, accessing member functions for an enterprise requires a card (for instance, a retailer card for accessing or verifying a membership with the retailer), login credentials, and/or the like. Accordingly, when making a purchase using a credit card, debit card, and/or the like that involves member functions, a customer is required to use the membership card (or login credentials) and then pay with the credit card, debit card, and/or the like. However, with a member-managed card, such as contactless card 102 according to some embodiments, a user may perform a transaction with a retailer that manages member functions (for instance, discounts, loyalty points, and/or the like), including in a secure manner, using cryptography and other data security functions according to various embodiments. In addition, the contactless card may also, in some embodiments, manage card payment functions along with member functions using a single card in a single transaction process. In some embodiments, the partner ID 432 may be included as part of the membership ID 430 (see, for example, FIG. 11).

The processor 402 and memory elements of the foregoing exemplary embodiments are described with reference to the contact pad 304, but the present disclosure is not limited thereto. It is understood that these elements may be implemented outside of the contact pad 304 or entirely separate from it, or as further elements in addition to processor 402 and memory 404 elements located within the contact pad 304.

In some examples, the contactless card 102 may comprise one or more antenna(s) 418. The one or more antenna(s) 418 may be placed within the contactless card 102 and around the processing circuitry 416 of the contact pad 304. For example, the one or more antenna(s) 418 may be integral with the processing circuitry 416 and the one or more antenna(s) 418 may be used with an external booster coil. As another example, the one or more antenna(s) 418 may be external to the contact pad 304 and the processing circuitry 416.

In an embodiment, the coil of contactless card 102 may act as the secondary of an air core transformer. The terminal may communicate with the contactless card 102 by cutting power or amplitude modulation. The contactless card 101 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 418, processor 402, and/or the memory 404, the contactless card 101 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 408 may be added to contactless cards to provide a one-time password (OTP) for multifactor authentication (MFA) in various mobile application-based use cases. Applet(s) 408 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 408 may be configured to encode the OTP as an NDEF type 4 well known type text tag. In some examples, NDEF messages may comprise one or more records. The applet(s) 408 may be configured to add one or more static tag records in addition to the OTP record.

In some examples, the one or more applet(s) 408 may be configured to emulate an RFID tag. The RFID tag may include one or more polymorphic tags. In some examples, each time the tag is read, different cryptographic data is presented that may indicate the authenticity of the contactless card. Based on the one or more applet(s) 408, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 410 may be configured to increment. In some examples, each time data from the contactless card 102 is read (e.g., by a mobile device), the counter(s) 410 is transmitted to the server for validation and determines whether the counter(s) 410 are equal (as part of the validation) to a counter of the server.

The one or more counter(s) 410 may be configured to prevent a replay attack. For example, if a cryptogram has been obtained and replayed, that cryptogram is immediately rejected if the counter(s) 410 has been read or used or otherwise passed over. If the counter(s) 410 has not been used, it may be replayed. In some examples, the counter that is incremented on the card is different from the counter that is incremented for transactions. The contactless card 101 is unable to determine the application transaction counter(s) 410 since there is no communication between applet(s) 408 on the contactless card 102.

In some examples, the counter(s) 410 may get out of sync. In some examples, to account for accidental reads that initiate transactions, such as reading at an angle, the counter(s) 410 may increment but the application does not process the counter(s) 410. In some examples, when the mobile device 10 is woken up, NFC may be enabled and the device 110 may be configured to read available tags, but no action is taken responsive to the reads.

To keep the counter(s) 410 in sync, an application, such as a background application, may be executed that would be configured to detect when the mobile device 110 wakes up and synchronize with the server of a banking system indicating that a read that occurred due to detection to then move the counter 104 forward. In other examples, Hashed One Time Password may be utilized such that a window of mis-synchronization may be accepted. For example, if within a threshold of 10, the counter(s) 410 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 410 increases in the appropriate sequence, then it possible to know that the user has done so.

The key diversification technique described herein with reference to the counter(s) 410, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, cryptographic keys may be assigned uniquely per card. In some embodiments, the cryptographic keys may include one or more sets of cryptographic keys, such as an issuer set of cryptographic keys (master keys associated with the issuer of the card) and/or a partner set of cryptographic keys (master keys or member master keys (MMKs) associated with a partner entity of the card).

The cryptographic keys may comprise symmetric keys which may be used in both encryption and decryption of data. Triple DES (3DES) algorithm may be used by EMV, and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

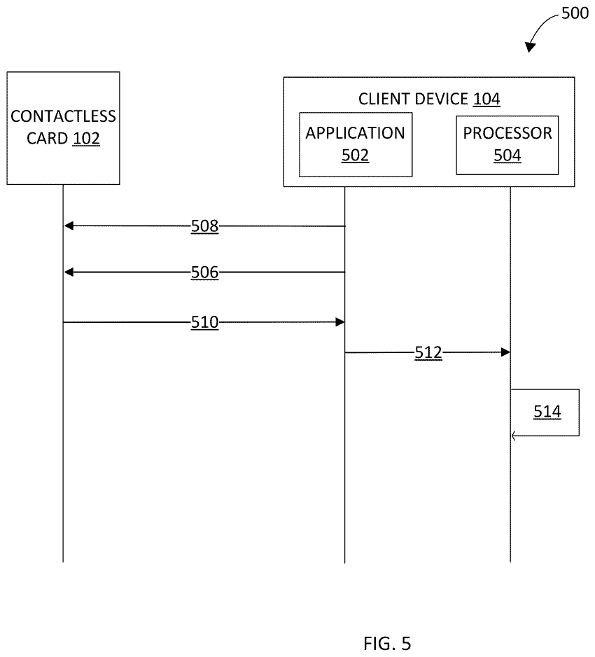

FIG. 5 is a timing diagram illustrating an example sequence for providing authenticated access according to one or more embodiments of the present disclosure. Sequence flow 500 may include contactless card 102 and client device 104, which may include an application 502 and processor 504.

At line 508, the application 502 communicates with the contactless card 102 (e.g., after being brought near the contactless card 102). Communication between the application 502 and the contactless card 102 may involve the contactless card 102 being sufficiently close to a card reader (not shown) of the client device 104 to enable data transfer (for instance, via NFC) between the application 502 and the contactless card 102.

At line 506, after communication has been established between client device 104 and contactless card 102, contactless card 102 generates a message authentication code (MAC) cryptogram. In some examples, this may occur when the contactless card 102 is read by the application 502. In particular, this may occur upon a read, such as an NFC read, of a near field data exchange (NDEF) tag, which may be created in accordance with the NFC Data Exchange Format. For example, a reader application, such as application 502, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 502 may be configured to transmit a request to contactless card 102, the request comprising an instruction to generate a MAC cryptogram.

At line 510, the contactless card 102 sends the MAC cryptogram to the application 502. In some examples, the transmission of the MAC cryptogram occurs via NFC, however, the present disclosure is not limited thereto. In other examples, this communication may occur via Bluetooth, Wi-Fi, or other means of wireless data communication. At line 512, the application 502 communicates the MAC cryptogram to the processor 504.

At line 514, the processor 504 verifies the MAC cryptogram pursuant to an instruction from the application 122. For example, the MAC cryptogram may be verified, as explained below. In some examples, verifying the MAC cryptogram may be performed by a device other than client device 104, such as a server of a banking system in data communication with the client device 104. For example, processor 504 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

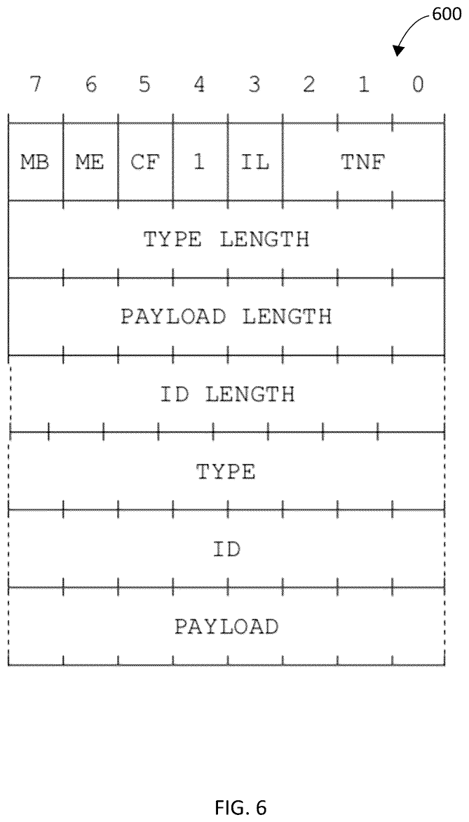

FIG. 6 illustrates an NDEF short-record layout (SR=1) data structure 600 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well-known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

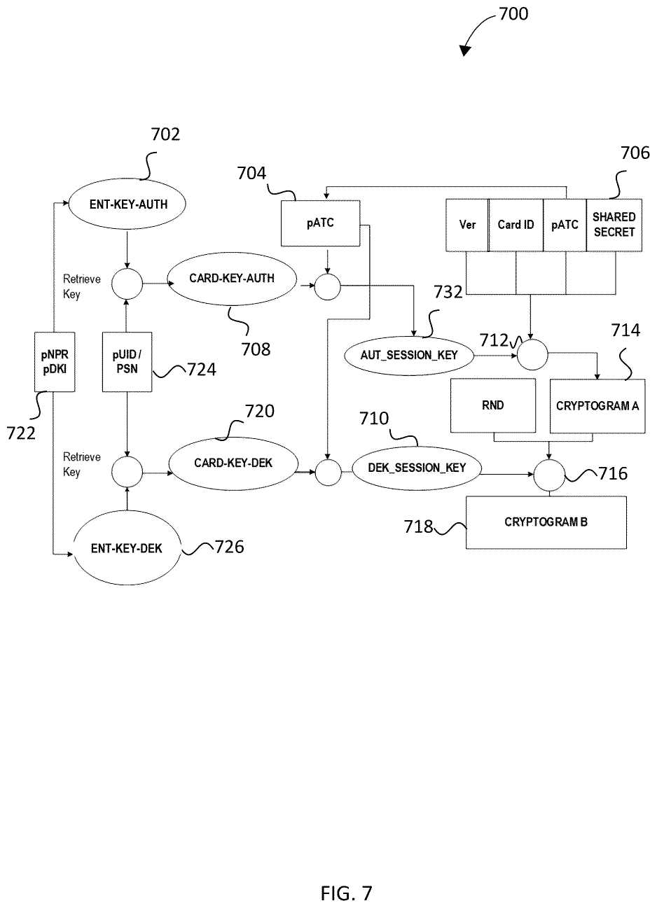

FIG. 7 illustrates a diagram of a system 700 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV, and it is implemented by hardware in the contactless card. By using a key diversification process, one or more keys may be derived from a master key based upon uniquely identifiable information for each entity that requires a key.

Regarding master key management, two entity master keys 702, 726 may be required for each part of the portfolio on which the one or more applets is issued. In some embodiments, at least one of the entity master keys 702, 726 may be an issuer master key associated with and/or specified by an issuer of the contactless card. In various embodiments, at least one of the entity master keys 702, 726 may be a membership master key associated with a membership and/or specified by a membership partner (for example, a retailer, shopping club, and/or the like).

In various embodiments, the first master key 702 may comprise an Entity Cryptogram Generation/Authentication Key (Ent-Key-Auth) and the second master key 726 may comprise an Entity Data Encryption Key (Ent-Key-DEK). As further explained herein, the two entity master keys 702, 726 are diversified into card master keys 708, 720, which are unique for each card. In some examples, a network profile record ID (pNPR) 722 and derivation key index (pDKI) 724, as back-office data, may be used to identify which Entity Master Keys 702, 726 to use in the cryptographic processes for authentication. The system performing the authentication may be configured to retrieve values of pNPR 722 and pDKI 724 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 708 and Card-Key-Dek 720). The session keys (Aut-Session-Key 732 and DEK-Session-Key 710) may be generated by the one or more applets and derived by using the application transaction counter (pATC) 704 with one or more algorithms. To fit data into the one or more algorithms, only the 2 low order bytes of the 4-byte pATC 704 is used. In some examples, the four-byte session key derivation method may comprise: F1:=PATC (lower 2 bytes)∥‘F0’∥‘00’∥PATC (four bytes) F1 :=PATC (lower 2 bytes)∥‘0F’∥‘00’∥ PATC (four bytes) SK :={(ALG (MK) [F1])∥ALG (MK) [F2]}, where ALG may include 3DES ECB and MK may include the card unique derived master key.

As described herein, one or more MAC session keys may be derived using the lower two bytes of pATC 704 counter. At each tap of the contactless card, pATC 704 is configured to be updated, and the card master keys Card-Key-AUTH 508 and Card-Key-DEK 720 are further diversified into the session keys Aut-Session-Key 732 and DEK-Session-KEY 710. pATC 704 may be initialized to zero at personalization or applet initialization time. In some examples, the pATC counter 704 may be initialized at or before personalization and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 732. The data specified in cryptogram may be processed with javacard. signature method: ALG_DES_MAC8_ISO9797_1_M2_ALG3 to correlate to EMV ARQC verification methods. The key used for this computation may include a session key AUT-Session-Key 732, as explained above. As explained above, the low order two bytes of the counter may be used to diversify for the one or more MAC session keys. As explained below, AUT-Session-Key 732 may be used to MAC data 706, and the resulting data or cryptogram A 714 and random number RND may be encrypted using DEK-Session-Key 710 to create cryptogram B or output 718 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 710 derived from the Card-Key-DEK 720. In this case, the ATC value for the session key derivation is the least significant byte of the counter pATC 704.

The format below represents a binary version example embodiment. Further, in some examples, the first byte may be set to ASCII ‘A’.

Message Format

| 1 | 2 | 4 | 8 | 8 |
|---|---|---|---|---|
| 0x43 (Message Type | Version | pATC | RND | Cryptogram A |
| ‘A’) | | | | (MAC) |

Cryptogram A (MAC) 8 bytes
MAC of

| 2 | 8 | 4 | 4 | 18 bytes input data |
|---|---|---|---|---|
| Version | pUID | pATC | Shared Secret | |

Message Format

| 1 | 2 | 4 | 16 |
|---|---|---|---|
| 0x43 | Version | pATC | Cryptogram B |
| (Message Type ‘A’) | | | |

Cryptogram A (MAC) 8 bytes
MAC of

| 2 | 8 | 4 | 4 | 18 bytes input data |
|---|---|---|---|---|
| Version | pUID | pATC | Shared Secret | |

Cryptogram B 16
Sym Encryption of

| 8 | 8 |
|---|---|
| RND | Cryptogram A |

Another exemplary format is shown below. In this example, the tag may be encoded in hexadecimal format.

Message Format

| 2 | 8 | 4 | 8 | 8 |
|---|---|---|---|---|
| Version | pUID | pATC | RND | Cryptogram A |
| | | | | (MAC) |

8 bytes

| 8 | 8 | 4 | 4 | 18 bytes input data |
|---|---|---|---|---|
| pUID | pUID | pATC | Shared Secret | |

Message Format

| 2 | 8 | 4 | 16 |
|---|---|---|---|
| Version | pUID | pATC | Cryptogram B |

8 bytes

| 8 | | 4 | 4 | 18 bytes input data |
|---|---|---|---|---|
| pUID | pUID | pATC | Shared Secret | |

Cryptogram B 16
Sym Encryption of

| 8 | 8 |
|---|---|
| RND | Cryptogram A |

The UID field of the received message may be extracted to derive, from master keys Ent-Key-AUTH 702 and Ent-Key-DEK 726, the card master keys (Card-Key-Auth 708 and Card-Key-DEK 720) for that particular card. Using the card master keys (Card-Key-Auth 708 and Card-Key-DEK 720), the counter (pATC) field of the received message may be used to derive the session keys (Aut-Session-Key 732 and DEK-Session-Key 710) for that particular card. Cryptogram B 718 may be decrypted using the DEK-Session-KEY 710, which yields cryptogram A 714 and RND, and RND may be discarded. The UID field may be used to look up the shared secret of the contactless card which, along with the Ver, UID, and pATC fields of the message, may be processed through the cryptographic MAC using the re-created Aut-Session-Key 732 to create a MAC output, such as MAC′. If MAC′ is the same as cryptogram A 714, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 732. The input data 706 may take the following form: Version (2), pUID (8), pATC (4), Shared Secret (4). In various embodiments, the pUID may be or may include a membership ID, member ID, partner ID, and/or a combination thereof. In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x′80′ byte to the end of input data and 0x′00′ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 712, data 706 is processed through the MAC using Aut-Session-Key 732 to produce MAC output (cryptogram A) 714, which is encrypted.

In order to provide additional protection against brute force attacks exposing the keys on the card, it is desirable that the MAC cryptogram 714 be enciphered. In some examples, data or cryptogram A 714 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 710. In the encryption operation 716, data or cryptogram A 714 and RND are processed using DEK-Session-Key 510 to produce encrypted data, cryptogram B 718. The data 714 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x′0000000000000000′ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram. In various embodiments, the pUID may be or may include a membership ID, a member ID, partner ID, and/or a combination thereof.

In some embodiments, the system 700 may operate to generate different types of cryptograms, for instance, based on the type of entity master keys 702, 726, the pDKI 724, MAC data 706, and/or other elements. For example, system 700 may include multiple sets of entity master keys 702, 726 (e.g., a membership set and an issuer set), multiple sets of pDKI 724 (e.g., a membership set and an issuer set), and/or multiple sets of MAC data 706 ((e.g., a membership set and an issuer set).

In various embodiments, for example, cryptogram B 718 may be generated as a membership cryptogram for membership functions associated with the contactless card 102. In exemplary embodiments, for instance, cryptogram B 718 may be generated as a transaction cryptogram for transaction (e.g., payment processing) functions. In various embodiments, the system 700 may only generate membership cryptograms for securely managing membership functions. In some embodiments, the system 700 may be capable of generating membership cryptograms for membership functions and a transaction cryptogram to process transaction functions.

For example, in various embodiments, the system 700 may use the membership master keys as the entity master keys 702, 726 to generate CARD-KEY-AUTH 708, CARD-KEY-DEK 720, AUT_SESSION_KEY 732, DEK_SESSION_KEY, and, ultimately, the cryptogram B 718 (i.e., a membership cryptogram). In some embodiments, the pDKI 724 may be or may include membership information (e.g., membership ID, member ID, etc.) when generating a membership cryptogram 718. For example, pUID may be a membership number with a partner entity assigned to the contactless card 102. In various embodiments, the MAC data 706 may be or may include membership information (e.g., membership ID, member ID, etc.) when generating a membership cryptogram 718.

For example, in various embodiments, the system 700 may use the issuer master keys as the entity master keys 702, 726 to generate CARD-KEY-AUTH 708, CARD-KEY-DEK 720, AUT SESSION KEY 732, DEK_SESSION_KEY, and, ultimately, the cryptogram B 718 (i.e., a transaction cryptogram). In some embodiments, the pDKI 724 may be or may include customer information (e.g., customer ID, issuer account number, etc.) when generating a transaction cryptogram 718. For example, pUID may be a membership number with a partner entity assigned to the contactless card 102. In various embodiments, the MAC data 706 may be or may include customer information (e.g., customer ID, issuer account number, etc.) when generating a transaction cryptogram 718.

In some embodiments, system 700 may only include one set of entity master keys 702, 726. In such embodiments, membership cryptograms 718 may be generated by using the entity master keys 702, 726 with membership information (e.g., a membership set of pDKI 724 and/or MAC data 706). Transaction cryptograms 718 may be generated by using the entity master keys 702, 726 with issuer information (e.g., an issuer set of pDKI 724 and/or MAC data 706).

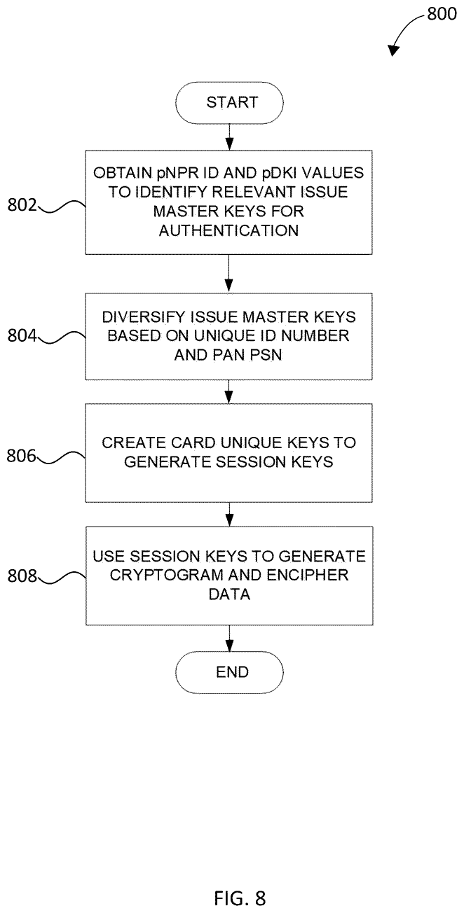

FIG. 8 illustrates a method 800 for generating a cryptogram. For example, at block 802, a network profile record ID (pNPR) and derivation key index (pDKI) may be used to identify which Entity Master Keys to use in the cryptographic processes for authentication. In some examples, the method may include performing the authentication to retrieve values of pNPR and pDKI for a contactless card at the time of authentication.

At block 804, Entity Master Keys may be diversified by combining them with one or more unique ID numbers associated with the card (e.g., pUID, membership ID, member ID, partner ID, combinations thereof, and/or the like) and the PAN sequence number (PSN) of one or more applets, for example, a payment applet.

At block 806, Card-Key-Auth and Card-Key-DEK (unique card keys) may be created by diversifying the Entity Master Keys to generate session keys which may be used to generate a MAC cryptogram.

At block 808, the keys used to generate the cryptogram and encipher the data in the one or more applets may comprise the session keys of block 1030 based on the card unique keys (Card-Key-Auth and Card-Key-DEK). In some examples, these session keys may be generated by the one or more applets and derived by using pATC, resulting in session keys Aut-Session-Key and DEK-Session-Key.

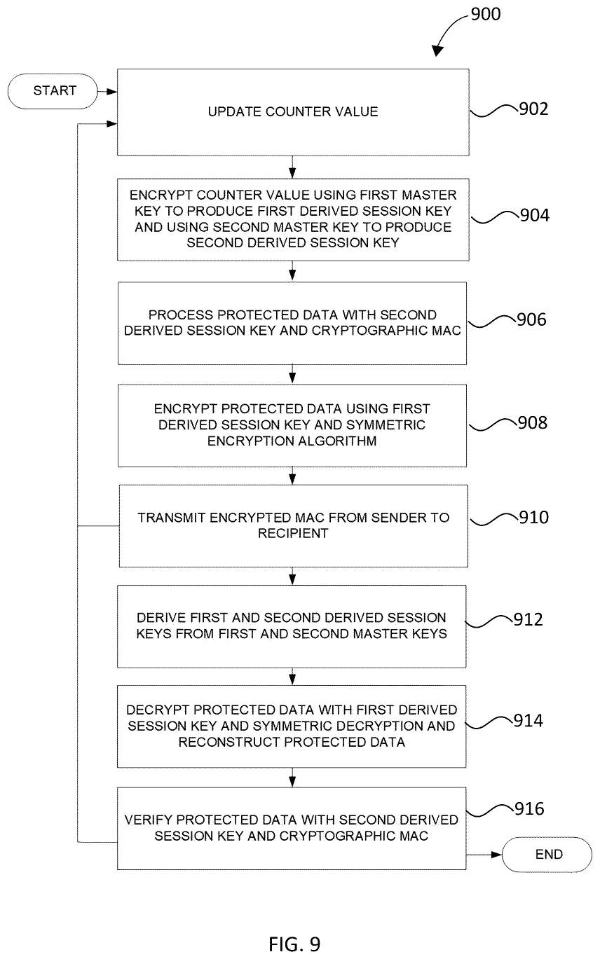

FIG. 9 depicts an exemplary process 900 illustrating key diversification according to some embodiments. Initially, a sender and the recipient may be provisioned with two different master keys (e.g., issuer master keys and/or member master keys). For example, a first master key may comprise the data encryption master key, and a second master key may comprise the data integrity master key. The sender has a counter value, which may be updated at block 902, and other data, such as data to be protected, which it may secure share with the recipient.

At block 904, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 906, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 908, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 910, the encrypted MAC is transmitted, from the sender to the recipient, with sufficient information to identify additional secret information (such as shared secret, master keys, etc.), for verification of the cryptogram.

At block 912, the recipient uses the received counter value to independently derive the two derived session keys from the two master keys as explained above.

At block 914, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 916, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 902) and a new set of session keys may be created (at block 910). In some examples, the combined random data may be discarded.

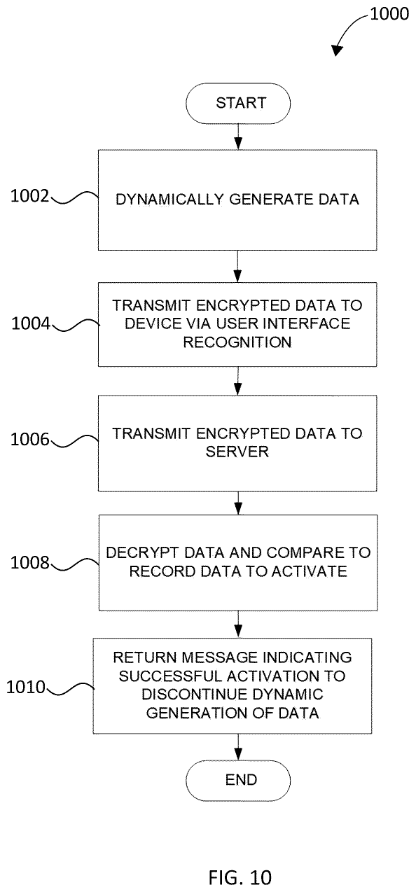

FIG. 10 illustrates a method 1000 for card activation according to an example embodiment. For example, card activation may be completed by a system including a card, a device, and one or more servers. The contactless card, device, and one or more servers may reference same or similar components that were previously explained, such as contactless card 102, client device 104, and a server 108.

In block 1002, the card may be configured to dynamically generate data. In some examples, this data may include information such as an account number, card identifier, card verification value, membership ID, member ID, partner ID, phone number, expiry date, combinations thereof, and/or the like, which may be transmitted from the card to the device. In some examples, one or more portions of the data may be encrypted via the systems and methods disclosed herein.

In block 1004, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1006, the one or more portions of the data may be communicated to one or more servers, such as a card issuer server, enterprise server (for instance, a server associated with a partner entity, retailer entity, and/or the like). For example, one or more encrypted portions of the data may be transmitted from the device to the card issuer server and/or partner entity server for activation of the card.

In block 1008, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1010, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

FIG. 11 depicts an exemplary operating environment consistent with some embodiments. As shown in FIG. 11, an operating environment 1100 may include a contactless card 102. A contactless card according to some embodiments (such as the contactless card 102) may be associated with one or more entities. For instance, in some embodiments, the contactless card 102 may be a “private label” or “co-branded” card. In general, a co-branded card may be issued by a financial services company that manages the financial services functions of the contactless card 102 for the card owner in partnership with a partner entity that manages membership functions of the card owner (as a member or customer of the partner entity).

For example, the contactless card 102 may be associated with a card issuer, which may be or may include a bank or other financial institution that provides the contactless card 102 (for instance, as a credit card, a debit card, and/or the like) to an issuer customer and provides financial services associated with the contactless card 102, including, without limitation, payment processing services, credit card transaction services, debit card transaction services, and/or the like. In another example, the contactless card 102 may be associated with a partner entity. In some embodiments, a partner entity may be an enterprise that does not provide financial services associated with the contactless card (e.g., payment processing services), but may provide other services, such as membership services (e.g., loyalty program, discounts, membership functions, and/or the like) for customers, members, or other individuals associated with the contactless card 102. The partner entity may be a retailer, shopping club, member-based organization, and/or the like. The partner entity may have members or customers that have memberships or accounts with the partner.

In some embodiments, the contactless card 102 may only provide membership services via secure processes according to various embodiments.

In one non-limiting example, the contactless card 102 may be issued by Capital One Financial Corporation (“Capital One”) of McLean, Virginia, United States of America (e.g., the card issuer) and the partner entity may be Costco Wholesale Corporation (“Costco”) of Issaquah, Washington, United States of America. In this non-limiting example, Capital One (or an entity, subsidiary, vendor, etc. thereof) may provide payment processing functions (via Capital One back-end systems, servers, databases, and/or the like) associated with the contactless card 102 and Costco (or an entity, subsidiary, vendor, etc., thereof) may provide membership functions (via Costco back-end systems, servers, databases, and/or the like) associated with the contactless card 102. However, embodiments are not so limited. For instance, a card issuer may also provide membership functions, a partner entity may provide payment processing functions (or other financial processing functions), and/or the like.

Referring to FIG. 11, the contactless card 102 may include a logic device 1104 (for instance, a device the same or similar to contact pad 304). Logic device 1104 may be configured to store one or more membership identifiers 1150a-n that may be associated with a user or owner of the contactless card 102. In some embodiments, the membership identifiers 1150a-n may be or may include a member ID, a partner ID, and/or a combination thereof. In various embodiments, the membership identifiers 1150a-n may be or may include a member ID, a partner ID, a pUID, a customer ID, an account number, a combination thereof, and/or the like. In some embodiments, the membership identifiers 1150a-n may include numeric values, alphanumeric values, letters, symbols, combinations thereof, and/or the like.

A membership identifier 1150a-n may be formed of various segments 1151, 1152 configured to identify an entity, user, membership, account, and/or the like. For example, in some embodiments, membership identifier 1150a may include a partner ID segment 1151 configured as a unique identifier to identify a partner entity and a member ID segment 1152 configured as a unique identifier to identify a membership of the card owner with the partner entity. The partner segment 1151 may operate as a namespace for a particular partner entity. For example, each contactless card 102 issued for Partner Entity A (for instance, Costco) may have a partner segment 1151 of “123;” each contactless card 102 issued for Partner Entity B may have a partner segment 1151 of “789;” and so on.

Partner entities may provide member IDs or account numbers to members thereof. These member IDs may be used by the partner entities to manage membership functions, such as loyalty points, discounts, purchasing privileges, and/or the like. For example, a customer may apply to be a member of a partner entity (for instance, a grocery store or shopping club) and the partner entity may provide a member (or customer with a registered account) with a membership or loyalty card (or a username and password for an online account). This membership card (or online account) may be associated with a number or member ID. When making a purchase at the partner entity using the membership card (or online account), the partner entity looks up the member ID in their back-end systems to process membership functions, such as determining loyalty points, discounts, purchasing privileges, and/or the like.

In some embodiments, the card owner segment may be, may include, or may be based on the card owner's member ID with the partner entity. For instance, Card Owner A may sign up to be a member of Partner Entity A (for example, Costco) and may be assigned a member ID (for instance, “456”) by Partner Entity A. Card Owner A may apply for the contactless card, which may be issued with an identifier 1150a stored on the contactless card that includes the partner ID 1151 of “123” (for Partner Entity A) and a member ID of “456.” Accordingly, the partner ID 1151 segment of membership identifier 1150a may be associated with Partner Entity A and the member ID 1152 segment may be associated with a membership of Card Owner A with Partner Entity A.

In general, and without the intent to limit, in the present disclosure, the term “member ID” may refer to a membership, customer, or account number provided by a partner entity to an individual (for instance, a membership number for a member of Costco provided by Costco), and the term “membership identifier” may refer to the membership information assigned to the contactless card (for instance, by the issuer when setting up the card), which may be or may include a member ID (alone or in combination with other information, such as a partner ID).

In some embodiments, when a user performs a transaction with the contactless card 102, information may be transmitted to the client device 104 (for example, a mobile device, a point-of-sale device, and/or the like). In various embodiments, the transmitted information may be or may include a membership identifier 1150a-n. In exemplary embodiments, an application being executed via logic device 1104 (for instance, the applet 408 of the contact pad 304) may perform a membership determination process in response to a signal (for instance, a transaction signal indicating that a transaction is being performed). The membership determination process may operate to determine which membership is the subject of the transaction and use the corresponding membership identifier 1150a-n (for instance, membership identifier 1150a for a transaction with Partner Entity A, membership identifier 1150n for a transaction with Partner Entity N, and so on). For example, the client device 104 may transmit partner identifier information (a partner ID or other information associated with the partner entity) to the contactless card 102. The contactless card 102 may use this partner identifier to select the corresponding membership identifier 1150a-n to use for the transaction. In various embodiments, the transmitted information may include all membership identifiers 1150a-n and the membership determination process may be performed by the client device 104 and/or back-end systems of the partner entity and/or card issuer (for instance, routing system 1170).

In some embodiments, the membership identifier 1150a-n may be transmitted in an unencrypted form. In various embodiments, the membership identifier 1150a-n may be transmitted in an encrypted form. In exemplary embodiments, the membership identifier 1150a-n may be transmitted in an encrypted form as part of a cryptogram according to some embodiments (for example, as a membership cryptogram 718 or 1222). In some embodiments, at least a portion of the membership identifier 1150a-n may be processed, for example, for formatting, padding, and/or the like before, during, or after transmission from the contactless card 102.

In some embodiments, the membership identifier 1150a-n may be transmitted to a partner entity processing (or back-end) system 1160a-n. In some embodiments, the client device 104 may be used to route the membership identifier 1150a-n (for example, in a data package, cryptogram, and/or the like) to the partner entity back-end system 160a-n. In some embodiments, a routing system 1170 (alone or in combination with the client device 104) may be used to route the membership identifier 1150a-n to the partner entity back-end system 160a-n. In various embodiments, the routing system 1170 may be or may be associated with the card issuer (for instance, the same or similar to servers 108, 202, 1208, and/or other back-end systems associated with a card issuer). For example, the routing system 1170 may operate the same or similar to servers 108, 202, or 1208 to decrypt the cryptogram to determine the membership identifier 1150a-n (for instance, the partner ID and the member ID), which may be routed to the corresponding partner for member lookup.

In exemplary embodiments, the partner ID of the membership identifier 1150a-n may be used to route the membership identifier 1150a-n to the corresponding partner entity back-end system 160a-n. For example, all membership identifiers 1150a-n with a partner ID segment 1151 of “123” may be routed to back-end system 1160a (associated with Partner Entity A) and all membership identifiers 1150a-n with a partner ID segment 1151 of “789” may be routed to back-end system 1160n (associated with Partner Entity B).

A partner entity back-end system 1160a-n may access or include a membership database 1161a-n with records for memberships of the associated partner entity. The member ID segment 1152 of the membership identifier 1150a-n may be used by the partner entity back-end system 1160a-n to look up the member associated with the membership identifier 1150a-n in the membership database 1161a-n. Membership information associated with the member may be obtained, such as account information, loyalty points, discounts, purchase privileges, transaction history, coupons, and/or the like. The membership information may be used to perform the transaction via the contactless card 102 the same or similar to the process with an individual partner entity membership card or account (such as applying discounts, recording transactions, and/or the like).

In some embodiments, the membership information (for example, the member ID) may be retrieved from the contactless card 102 and provided to the client device 104 for processing by the partner entity the same or similar as when retrieving the information from a conventional membership card (for example, the logic device 1104 transmits the member ID to the client device 1104, which transmits the member ID to the partner back-end system 1160a-n).

In some embodiments, the routing system 1170 (for instance, operating as an issuer back-end system, such as server 108, 202, or 1208) may decrypt the cryptogram to determine the membership information, such as the partner ID and/or member ID. The partner entity, such as via partner entity back-end system 1160a-n, may retrieve the member ID (or other membership information) from the card issuer system, such as using an API call or similar function.

In some embodiments, the member ID may not be stored on the contactless card 102; instead, the member ID may be retrieved from a partner entity during a transaction based on another unique ID stored on the contactless card. For example, the member ID segment 1152 may not store the member ID (for instance, the membership or account number of the card owner with the partner entity); rather, the member ID segment 1152 stores another unique ID (such as an account number) of the user, such as a customer ID or account number of the user with the card issuer. The unique ID may be routed to the partner entity back-end 1160a-n, which may use the unique ID to determine the member and their member ID (for instance, via a database lookup in the partner entity database 1161a-n). This member ID may then be transmitted by the partner entity back-end 1160a-n to the client device 104 for processing of the member functions based on the member ID. In various embodiments, the member ID may be transmitted in a cryptogram generated according to some embodiments (for instance, cryptogram 718, cryptogram 1222, and/or the like). For example, the partner entity back-end 1160a-n may include software capable of operating the same or similar to system 700 and/or servers 202 or 1208 to generate cryptograms. The cryptograms may be resolved via the contactless card 102 and/or client device 104 according to some embodiments.

In various embodiments, the membership information (such as member ID), may include membership status information indicating a status of the membership associated with the partner entity. For example, the membership status information may include an expiration date of when the membership expires, an active status indicator to indicate whether the membership is active or deactivated, and/or the like. In this manner, the membership information may be used, for instance, directly via the client device 104, to determine the status of a membership, such as whether it has expired or has been deactivated.

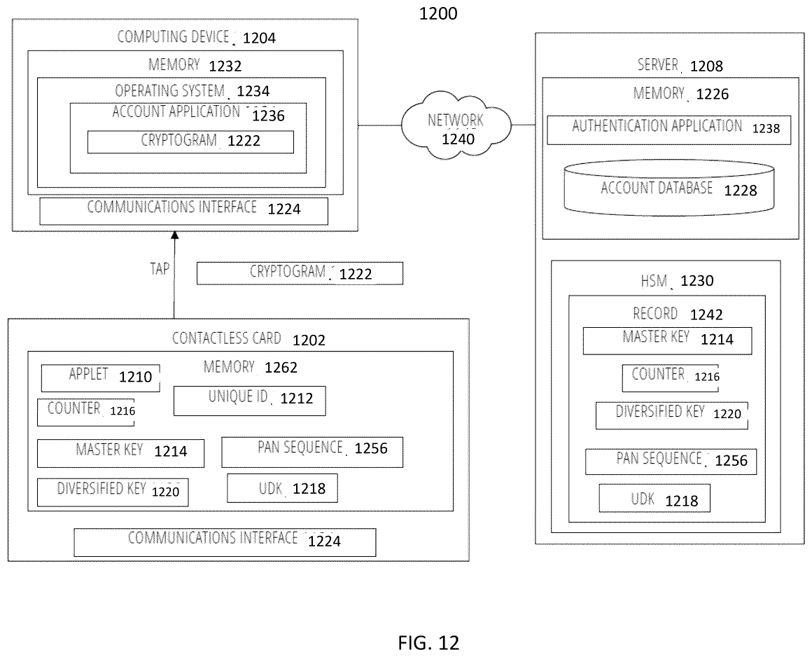

FIG. 12 depicts an exemplary computing architecture 1200, also referred to as a system, consistent with some embodiments of the present disclosure. Although the computing architecture 1200 shown in FIG. 12 has a limited number of elements in a certain topology, it may be appreciated that the computing architecture 1200 may include more or less elements in alternate topologies as desired for a given implementation.

The computing architecture 1200 may include one or more computing devices 1204, one or more servers 1206, and one or more contactless cards 1204. The contactless card 1202 may be or may be the same or similar to the contactless card 102; the computing device 1204 may be the same or similar to the computing device 104; and the server 1208 may be the same or similar to the server 108. The computing device 1204 may be communicably coupled to the server 1208 via network 1240.

As shown in FIG. 12, a memory 1262 of the contactless card 1202 may include an applet 1210, a counter 1216, one or more master keys 1214, one or more diversified keys 1220, a unique ID 1212, a primary account number (PAN) sequence number 1256, and one or more Unique Derived Keys (UDKs) 1218. The unique ID 1212 may be any identifier that uniquely identifies the contactless card 1202 relative to other contactless cards. For example, in some embodiments, unique ID 1212 may be or may include an identifier 1150a-n, a member ID 430, a partner ID 432, a customer ID 414, and/or the like. The PAN sequence 1256 may include a counter value stored by the contactless card 1202. The applet 1210 may be or may include executable code configured to perform some or all of the operations described in the present disclosure. The counter 1216 is a value that is synchronized between the contactless card 1202 and server 1208. The counter 1216 may comprise a number that changes each time data is exchanged between the contactless card 1202 and the server 1208 (and/or the contactless card 1202 and the computing device 1204). The counter 1216, master keys 1214, diversified keys 1220, UDKs 1218, PAN sequence 1256, and/or unique ID 1212 are used to provide security in the system 1200 as described in greater detail below.

A memory 1232 of the computing device 1204 may include an instance of an operating system 1234. Non-limiting example operating systems may include the Android® OS, iOS®, macOS®, Linux®, and Windows® operating systems. As shown, the operating system 1234 includes an account application 1236. The account application 1236 allows users to perform various account-related operations, processing transactions, processing membership functions, activating payment cards, viewing account balances, purchasing items, processing payments, and/or the like.

As shown, a memory 1226 of the server 1208 may include an authentication application 1238 and an account database 1228. The account database 1228 generally includes information related to an account holder (e.g., one or more users, card owners, partner members, and/or the like), one or more accounts of the account holder, and one or more contactless cards 1204 of the account. In some embodiments, account database 1228 may include a membership database (for instance, the same or similar to database 1161a-n) of a partner entity system (for instance, the same or similar to system 1160a-n).

In the embodiment depicted in FIG. 12, the user may tap the contactless card 1202 to the computing device 1204 (or otherwise bring the contactless card 1202 within communications range of the communications interface 1224 of the device 1204). The account application 1236 may then instruct the applet 1210 to generate a cryptogram 1222. The cryptogram 1222 may be generated based on any suitable cryptographic technique. In some embodiments, the cryptogram 1222 may be based on the unique ID 1212 of the contactless card 1202. In some embodiments, the applet 1210 may include the cryptogram 1222 and an unencrypted identifier (e.g., the counter 1216, the PAN sequence 1256, the unique ID 1212, and/or any other unique identifier) as part of a data package including the cryptogram 1222. In at least one embodiment, the data package may be or may include an NDEF file.

In some embodiments, the computing architecture 1200 may be configured to implement key diversification to secure data, which may be referred to as a key diversification technique in the present disclosure. Generally, the server 1208 (or another computing device) and the contactless card 1202 may be provisioned with the same master key 1214 (also referred to as a master symmetric key). More specifically, each contactless card 1202 is programmed with a distinct master key 1214 that has a corresponding pair in the hardware security module (HSM) 1230 of the server 1208. For example, when a contactless card 1202 is manufactured, a unique master key 1214 may be programmed into the memory 1262 of the contactless card 1202. Similarly, the unique master key 1214 may be stored in a record 1242 in the HSM 1230. In some embodiments, the master key 1214 may include an issuer master key or keys and/or a partner master key or keys.

Furthermore, when a given card 1202 is manufactured, a UDK 1218 may be diversified from the master key 1214 via an HSM function that takes, as input, a diversification factor and a reference to the master key 1214 index in the HSM 1230 (e.g., an index to the record 1242). In some embodiments, the diversification factor may be the unique ID 1212 (for instance, a membership identifier 1150a-n, customer ID, member ID, and/or the like) and the PAN sequence 1256 of the contactless card 1202. The UDK 1218 may be stored in the contactless card 1202 and the record 1242 of the HSM 1230. The master key 1214 and UDK 1218 may be kept secret from all parties other than the contactless card 1202 and server 1208, thereby enhancing security of the system 1200. Although depicted as being stored in the record 1242, in some embodiments, the counter 1216 and/or the PAN sequence 1256 are not stored in the HSM 1230. For example, the unique ID 1212, counter 1216, and PAN sequence 1256 may be stored in the account database 1228.

In some embodiments, to generate the cryptogram 1222, the applet 1210 may provide the UDK 1218, unique ID 1212, and a diversification factor as input to a cryptographic algorithm, thereby producing a diversified key 1220. In some embodiments, the diversification factor is the counter 1216. In other embodiments, the PAN sequence 1256 is the diversification factor. The diversified key 1220 may then be used to encrypt some data, such as the diversification factor (e.g., the counter 1216 and/or the PAN sequence 1256) or other sensitive data. The applet 1210 and the server 1208 may be configured to encrypt the same type of data to facilitate the decryption and/or verification processing of a cryptogram.

As stated, the UDKs 1218 of the contactless card 1202 and server 1208 may be used in conjunction with the counters 1216 to enhance security using key diversification. As stated, the counters 1216 comprise values that are synchronized between the contactless card 1202 and server 1208. The counter 1216 may comprise a number that changes each time data is exchanged between the contactless card 1202 and the server 1208 (and/or the contactless card 1202 and the computing device 1204). When preparing to send data (e.g., to the server 1208 and/or the device 1204), the applet 1210 of the contactless card 1202 may increment the counter 1216. The applet 1210 of the contactless card 1202 may then provide the UDK 1218, unique ID 1212, and counter 1216 as input to a cryptographic algorithm, which produces a diversified key 1220 as output. The cryptographic algorithm may include encryption algorithms, hash-based message authentication code (HMAC) algorithms, cipher-based message authentication code (CMAC) algorithms, and the like. Non-limiting examples of the cryptographic algorithm may include a symmetric encryption algorithm such as 3DES or AES107; a symmetric HMAC algorithm, such as HMAC-SHA-256; and a symmetric CMAC algorithm such as AES-CMAC. Examples of key diversification techniques are described in greater detail in U.S. Pat. No. 10,581,611, titled “Systems and Methods for Cryptographic Authentication of Contactless Cards,” which is incorporated by reference herein in its entirety. In some embodiments, the PAN sequence 1256 is used as input to the cryptographic algorithm instead of the counter 1216 to generate the diversified key 1220, e.g., by encrypting the UDK 1218, unique ID 1212, and PAN sequence 1256.

The applet 1210 may then encrypt some data (e.g., the unique ID 1212, the counter 1216, the PAN sequence 1256, a command, and/or any other data) using the diversified key 1220 and the data as input to the cryptographic algorithm. For example, encrypting the unique ID 1212 with the diversified key 1220 may result in an encrypted unique ID 1212 (e.g., a cryptogram 1222). As stated, the applet 1210 and the server 1208 may be configured to encrypt the same data.

In some embodiments, two diversified keys 1220 may be generated, e.g., based on one or more portions of the input to the cryptographic function. In some embodiments, the two diversified keys 1220 are generated based on two distinct master keys 1214, two distinct UDKs 1218, the unique ID 1212, and the counter 1216 (or the PAN sequence 1256). In such embodiments, a message authentication code (MAC) is generated using one of the diversified keys 1220, and the MAC may be encrypted using the other one of the diversified keys 1220. The MAC may be generated based on any suitable data input to a MAC algorithm, such as sensitive data, the unique ID 1212, the counter 1216, and/or the PAN sequence 1256. More generally, the applet 1210 and the server 1208 may be configured to generate the MAC based on the same data. In some embodiments, the cryptogram 1222 is included in a data package such as an NDEF file. The account application 1236 may then read the data package including cryptogram 1222 via the communications interface 1224 of the computing device 1204.

In some embodiments, cryptogram 1222 may be a membership cryptogram. In various embodiments, cryptogram 1222 may be a transaction cryptogram. In some embodiments, the server 1208 may be a card-issuer server used to process transactions for the contactless card 1202. For example, server 1208 may be a card-issuer server configured to decrypt transaction cryptograms. In various embodiments, the server 1208 may be a partner entity server (for instance, system 1160-an) used to process membership functions for the contactless card. For example, server 1208 may be a partner entity server configured to decrypt membership cryptograms.

In some embodiments, the systems and processes described in FIGS. 7-10 and 12 may generate and/or use cryptograms based on different entity master keys and/or card ID information. According to some embodiments, a contactless card may be used for one or more of transaction functions (for example, processing a transaction, purchase, payment, and/or the like typical for a credit card, debit card, and/or the like) and membership functions (for example, applying membership benefits, such as loyalty points, coupons, discounts, purchasing privileges, and/or the like).

In some embodiments, one set of master keys may be used for both financial functions and membership functions. In exemplary embodiments, one cryptogram (for instance, generated using a single set of master keys and a single identifier) may be used for both financial functions and membership functions. In various embodiments, different sets of master keys may be used for financial functions and membership functions. In some embodiments, different unique ID information may be used for financial functions and membership functions.

For example, in various embodiments, a first set of master keys (for example, membership master keys) may be used to generate a first cryptogram (for instance, cryptogram B 718 of FIG. 7 or cryptogram 1222 of FIG. 12) for membership functions and a second set of master keys (for example, issuer master keys) may be used to generate a second cryptogram for transaction functions. For instance, for a purchase, a first cryptogram may be generated and used with a partner back-end system to determine membership information from a partner entity to determine discounts, etc., and the second cryptogram may be generated and used with a card issuer back-end system to process the payment via the card issuer.

In another example, in some embodiments, a single set of master keys may be used with different unique ID information to generate a first cryptogram (for the partner entity) and a second cryptogram (for the card issuer to process the transaction). For instance, the entity master keys may be used with a membership identifier (for example, a member ID of the user with the partner entity) to generate a first cryptogram that may be used by the partner entity to process the membership functions, and the entity master keys may be used with an issuer identifier (for example, a customer or account number of the user with the card issuer) to generate a second cryptogram that may be used by the card issuer to complete the payment process using the contactless card.

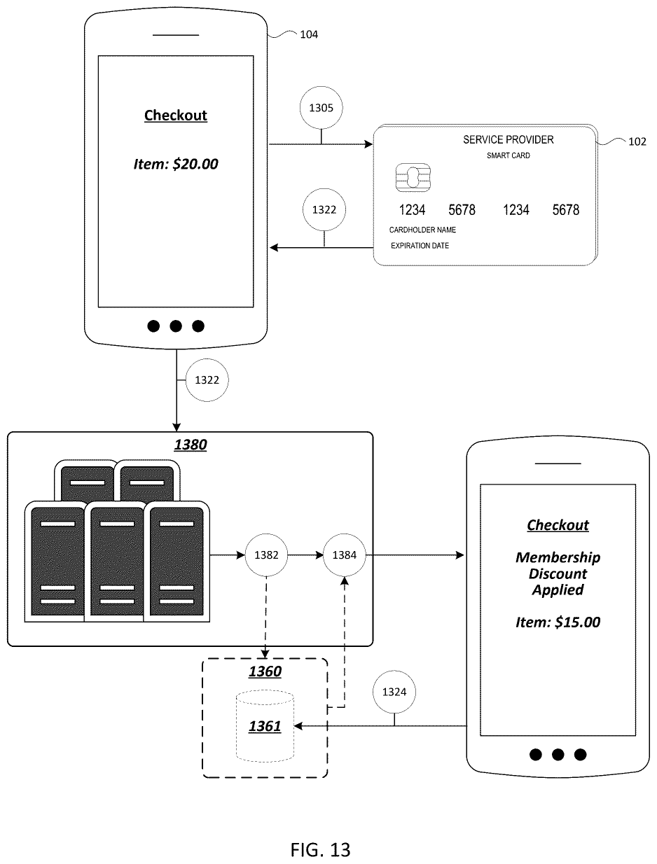

FIG. 13 depicts an exemplary operating environment in accordance with some embodiments. As shown in FIG. 13, an operating environment 1300 may include a contactless card 102. During a transaction, such as before or during a checkout process, the contactless card 102 may be brought into proximity with a client device 104 to initiate communication between the contactless card 102 and the client device according to some embodiments. The contactless card 102 may determine that a membership process or function is active, for instance, via a transaction signal 1305 sent by the client device indicating a transaction or requesting information from the contactless card 102.

The contactless card 102 may transmit a cryptogram 1322 (for instance, the same or similar to cryptogram 718 or 1222) to the client device. The cryptogram 1322 may be a membership cryptogram, for example, that includes membership information. The membership information may include an identifier 1150a-n, a membership identifier, a member ID, a partner ID, and/or any other information associated with a membership with a partner entity that corresponds to the membership function of the transaction. For example, the cryptogram 1322 may include a cryptogram generated using membership master keys (and other elements derived therefrom, such as diversified keys) encrypting membership information (such as an identifier 1150a-n, a member ID, a partner ID, and/or the like).

The cryptogram 1322 may be routed to a back-end system 1380 (for instance, the same or similar to server 108, server 202, server 1208, and/or the like). The cryptogram 1322 may be authenticated 1382 by back-end processing system 1380. In some embodiments, membership information 1384 may be determined from cryptogram 1322, such as a member ID, partner ID, and/or the like encrypted in the cryptogram 1322. In some embodiments, a membership information 1384 may be determined directly from the contactless card 102 (and not from a decryption result of cryptogram 1322). For example, successful authentication 1382 of the cryptogram 1322 may be communicated to the contactless card 102 (for instance, from back-end system 1380, to client device 104, and then to the contactless card 102). The indication of a successful authentication 1382 may cause the contactless card 102 to transmit or release the membership information (e.g., member ID, etc.) to the client device 104, which may then be promulgated to determine member benefits, etc.

In various embodiments, a partner entity back-end system 1360 may be used to determine the membership information 1384, for instance, via a membership database 1361 based on information decrypted in the cryptogram 1322. In exemplary embodiments, the membership information 1384 may include member benefits, such as discounts, rewards, and/or the like. For example, the transaction may be processed to apply a discount for a purchase price. In various embodiments, membership transaction data 1324 may be sent from the client device 104 to the partner entity back-end system 1360 to record the transaction and associated information (e.g., discounts, loyalty points, rewards, etc.).

Included herein are one or more logic flows representative of exemplary methodologies for performing novel aspects of the disclosed embodiments. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation. Blocks designated with dotted lines may be optional blocks of a logic flow.

A logic flow may be implemented in software, firmware, hardware, or any combination thereof. In software and firmware embodiments, a logic flow may be implemented by computer executable instructions stored on a non-transitory computer readable medium or machine readable medium. The embodiments are not limited in this context.

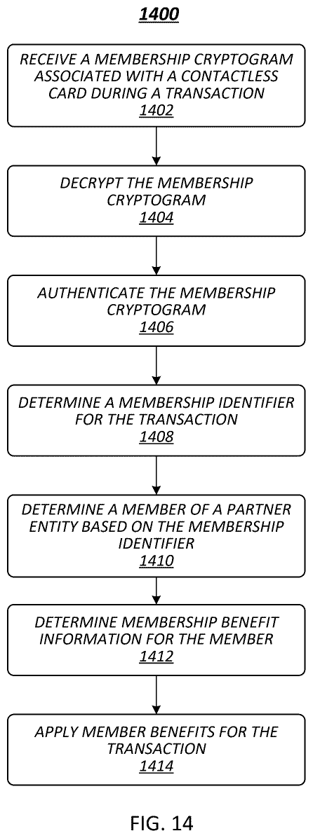

FIG. 14 illustrates an embodiment of a logic flow 1400. The logic flow 1400 may be representative of some or all of the operations executed by one or more embodiments described herein, such as the client devices 104, 1104, and/or 1204 and/or servers or back-end systems 108, 202, 1170, 1160a-n, and/or 1208. In some embodiments, logic flow 1400 may be representative of some or all of the operations processing a transaction using a contactless card according to some embodiments.

At block 1402, the logic flow 1400 may receive a membership cryptogram associated with a contactless card during a transaction. For example, a contactless card 102 may transmit a cryptogram 1222 during a transaction facilitated via a client device 104. In some embodiments, the cryptogram may include encrypted membership information, such as a member ID, partner ID, and/or the like. In some embodiments, the cryptogram may be generated using membership master keys associated with a partner entity corresponding to the contactless card.

The logic flow 1400 may decrypt the membership cryptogram at block 1404. For example, the server 1208 may decrypt the cryptogram 1222 using a master key 1214 stored on a HSM 1230 of the server 1208. At block 1406, the logic flow 1400 may authenticate the membership cryptogram. For example, an authentication application 1238 of server 1208 may be used to authenticate the cryptogram 1222. If the cryptogram is authenticated at block 1406, the logic flow 1400 may continue with block 1408.

At block 1408, the logic flow 1400 may determine a membership identifier for the transaction. For example, a membership identifier (for instance, identifier 1150a-n, a member ID, a partner ID, and/or the like) may be included in the cryptogram. Accordingly, the decryption result of decrypting the cryptogram may be used to determine the membership identifier portion. In another example, a successful authentication result may be communicated to the contactless card and, in response, the contactless card may provide the membership information (either in encrypted or non-encrypted form). For instance, the successful authentication of the cryptogram may operate to release or unlock the membership information stored on the contactless card for use in the transaction.

At block 1410, the logic flow 1400 may determine a member of the partner entity based on the membership identifier. For example, the membership identifier may be communicated to the partner entity (or a back-end processing system thereof). The partner entity system may look up the member in a membership database using the membership identifier. Logic flow 1400 may determine membership benefit information for the member at block 1412. For example, the membership benefit information for the determined member may be located in the membership database. The membership benefit information may include benefits, functions, perks, discounts, loyalty or reward points, coupons, and/or the like available to the member. At block 1414, the logic flow 1400 may apply the member benefits for the transaction. For example, a discount may be applied for a purchase, reward or loyalty points may be accrued, and/or the like.

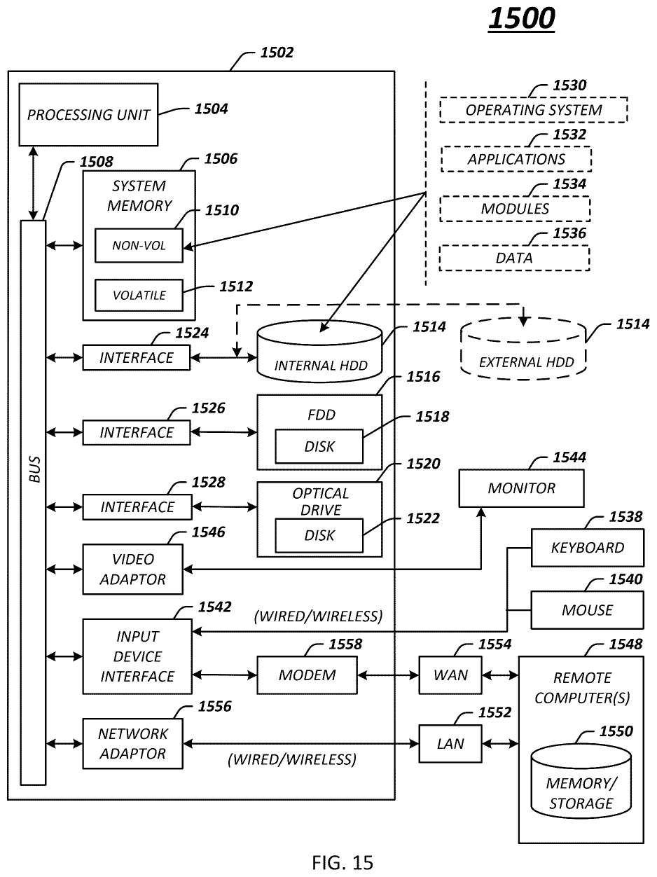

FIG. 15 illustrates an embodiment of an exemplary computer architecture 1500 suitable for implementing various embodiments as previously described. In one embodiment, the computer architecture 1500 may include or be implemented as part of computing architecture 100.

As used in this application, the terms “system” and “component” are intended to refer to a computer-related entity, either hardware, a combination of hardware and software, software, or software in execution, examples of which are provided by the exemplary computing computer architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 1500.

As shown in FIG. 15, the computer architecture 1500 includes a computer 1512 comprising a processor 1502, a system memory 1504 and a system bus 1506. The processor 1502 can be any of various commercially available processors. The computer 1512 may be representative of the client device 104 and/or the server 108.

The system bus 1506 provides an interface for system components including, but not limited to, the system memory 1504 to the processor 1502. The system bus 1506 can be any of several types of bus structure that may further interconnect to a memory bus (with or without a memory controller), a peripheral bus, and a local bus using any of a variety of commercially available bus architectures. Interface adapters may connect to the system bus 1506 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 1500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1504 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1504 can include non-volatile 1508 and/or volatile 1510. A basic input/output system (BIOS) can be stored in the non-volatile 1508.

The computer 1512 may include various types of computer-readable storage media in the form of one or more lower speed memory units, including an internal (or external) hard disk drive 1514, a magnetic disk drive 1516 to read from or write to a removable magnetic disk 1518, and an optical disk drive 1520 to read from or write to a removable optical disk 1522 (e.g., a CD-ROM or DVD). The hard disk drive 1514, magnetic disk drive 1516 and optical disk drive 1520 can be connected to the system bus 1506 by an HDD interface 1524, and FDD interface 1526 and an optical disk drive interface 1528, respectively. The HDD interface 1524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1508, and volatile 1510, including an operating system 1530, one or more applications 1532, other program modules 1534, and program data 1536. In one embodiment, the one or more applications 1532, other program modules 1534, and program data 1536 can include, for example, the various applications and/or components of the system 100.

A user can enter commands and information into the computer 1512 through one or more wire/wireless input devices, for example, a keyboard 1538 and a pointing device, such as a mouse 1540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1502 through an input device interface 1542 that is coupled to the system bus 1506 but can be connected by other interfaces such as a parallel port, IEEE 1394 serial port, a game port, a USB port, an IR interface, and so forth.

A monitor 1544 or other type of display device is also connected to the system bus 1506 via an interface, such as a video adapter 1546. The monitor 1544 may be internal or external to the computer 1512. In addition to the monitor 1544, a computer typically includes other peripheral output devices, such as speakers, printers, and so forth.

The computer 1512 may operate in a networked environment using logical connections via wire and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all the elements described relative to the computer 1512, although, for purposes of brevity, only a memory and/or storage device 1550 is illustrated. The logical connections depicted include wire/wireless connectivity to a local area network 1552 and/or larger networks, for example, a wide area network 1554. Such LAN and WAN networking environments are commonplace in offices and companies, and facilitate enterprise-wide computer networks, such as intranets, all of which may connect to a global communications network, for example, the Internet.

When used in a local area network 1552 networking environment, the computer 1512 is connected to the local area network 1552 through a wire and/or wireless communication network interface or network adapter 1556. The network adapter 1556 can facilitate wire and/or wireless communications to the local area network 1552, which may also include a wireless access point disposed thereon for communicating with the wireless functionality of the network adapter 1556.

When used in a wide area network 1554 networking environment, the computer 1512 can include a modem 1558, or is connected to a communications server on the wide area network 1554 or has other means for establishing communications over the wide area network 1554, such as by way of the Internet. The modem 1558, which can be internal or external and a wire and/or wireless device, connects to the system bus 1506 via the input device interface 1542. In a networked environment, program modules depicted relative to the computer 1512, or portions thereof, can be stored in the remote memory and/or storage device 1550. It will be appreciated that the network connections shown are exemplary and other means of establishing a communications link between the computers can be used.

The computer 1512 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ax, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1A-12 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A system, comprising:
at least one server comprising a processor and a memory storing instructions that, when executed by the processor, cause the processor to:
receive, via a client device, a membership cryptogram generated by a contactless card in communication with the client device during a transaction, the contactless card associated with at least one partner entity having a plurality of members,
decrypt the membership cryptogram based on at least one master key for the contactless card to determine a decryption result,
authenticate the membership cryptogram based on the decryption result, and
responsive to authentication of the membership cryptogram:
determine a membership identifier for the transaction,
determine a member of the plurality of members based on the membership identifier, and
transmit membership benefit information to the client device to facilitate at least one membership function associated with the member for the transaction.
